(19) United States
(12) Patent Application Publication
(10) Pub. No.: US 2010/0153867 A1
(43) Pub. Date: Jun. 17, 2010

(54) METHOD AND SYSTEM FOR SOCIAL NETWORKING, ADVERTISEMENT, DISTRIBUTING CONSUMER BEHAVIOR TRACKING DEVICES, AND HARVESTING CONSUMER BEHAVIOR DATA

(76) Inventors: Michael Scott, New York, NY (US); Johnlouis Petitbon, Brooklyn, NY (US); Mauro Catenacci, Brooklyn, NY (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 12/640,901

(22) Filed: Dec. 17, 2009

Related U.S. Application Data
(60) Provisional application No. 61/138,362, filed on Dec. 17, 2008.

(51) Int. Cl. G06F 3/00

(52) U.S. Cl. 715/762

(57) ABSTRACT

A method and system of social networking is provided. A computer-readable medium including instructions for the social network is also provided. The method or system can include mutable widgets. A user decorates a room web page with the mutable widgets and can change the look and content of the widget. The widget can include tracking features and advertisements. A user can visit other rooms and copy widgets and the content of the widgets to the user's room.

This application claims the benefit of U.S. provisional application No. 61/138,362, which was filed on Dec. 17, 2008 and is incorporated herein by reference as if fully set forth.

### BACKGROUND

Social networking leverages an individual's online personal network to find more relevant connections for dating, job networking, service referrals, activity partners, and the like. On a broad scale, a social network refers to a set of social entities that interact and exchange information in a social relationship. Social entities include, for example, people, teams, groups, organizations, and countries, while social relationships include, for example, friendship, employment, or other relationships between these social entities. Because individuals are more likely to trust and value opinions from people they know, in comparison to opinions from complete strangers, social networking is typically directed towards mining personal network relationships. The methods of social networking can extend the information mined in a way that is often more difficult to do offline. To facilitate the process, some social networking methods allow a user to customize personal information. See U.S. Pat. No. 7,269,590, which is incorporated by reference herein as if fully set forth. As described in U.S. Pat. No. 7,269,590, user-defined criteria is inputted. The user-defined criteria may include degrees of separation between members of the social network, a relationship to the prospective viewer, as well as criteria based on activities such as dating, employment, or hobbies. The user-defined criteria may also be based on a group membership, a strength of a relationship, and the like. Such user-defined relationship criteria can then be mapped against various categories of information associated with a social network user to provide customized views of the social network user. The customized views could provide an enhanced way to mine personal network relationships.

Cyworld (www.cyworld.com) allows users to design rooms as one of many ways its users can display their interests. However, the furnishings and accessories do not encapsulate media and do not appear to serve in any networking capacity. Lively (www.lively.com) was similar in that users designed rooms, chose furnishings for their rooms and then chose avatars (digital or virtual character) whose clothing and appearance could have been customized by the user. However, Lively's rooms, avatars (and components of avatars such as hairstyles and clothing) and furnishings were all chosen from a pre-set catalog of options. In addition, no component of Lively's landscape, aside from a room name (assigned by the user), appeared to be tagged, and therefore was not used in a networking capacity. Finally, Lively appeared to be focused on movement of a user's avatar from room to room in a video game-like manner and aesthetic.

Information about users of a social network can also be collected. Traditional techniques for monitoring social relationships rely on manual data collection, such as questionnaires, interviews, observations, and self-assessment surveys. Intrusive harvesting of data from social networks is described in U.S. Pat. No. 7,366,759, which is incorporated by reference herein as if fully set forth. Intrusive data harvesting involves electronic eavesdropping into a user's communication with other users over the social network. The data obtained is then processed in a complex manner to determine patterns in the communication and the quality of a social networking relationship.

There is at least one well-known tool for gathering site user statistics: Google Analytics. This service allows website owners, publishers and advertisers to understand where their visitors come from and how they are interacting with their website. Information including how many visitors viewed a particular site, how long visitors viewed the site and in what geographic area users are located is provided so that marketing campaigns can be tailored more accurately and businesses can better convert browsers of their site into purchasers of their (or their advertisers') products and content. Professionals interested in learning about a social networker's behavior could also track user-input data or use intrusive data harvesting to conduct their research. However, user-input data and communications within a social network are limited to features within the narrow sphere of an individual user's network. In addition, user-input data does not appear to be dynamically updated based on a user's behavior.

### SUMMARY

In an aspect, the invention relates to a system for implementing a social network. The system includes a network having a plurality of client devices including a first client device and a second client device; one or more servers, and network connectivity channels operably connecting the plurality of client devices and the one or more servers. The system also having a computer-readable medium and social network instructions encoded on the computer-readable medium. Each of the plurality of client devices includes respective client processors, and each of the one or more servers including respective server processors configured to implement the social network instructions. Implementation of the social network instructions includes providing system graphical user interface data from the server to two or more of the plurality of client devices, wherein the respective client processors process the system graphical user interface data to display a system graphical user interface on the respective client devices. The system graphical user interface can be configured to i) receive respective client data inputted by a respective user to establish a respective user workspace and populate the respective user workspace with one or more respective user graphical elements by performing at least one of creating a new graphical element or copying at least one pre-made graphical element and ii) associating additional data with at least one of the one or more graphical elements. Implementation of the social network instructions also includes the server providing second user client data to the first client device, wherein the first client device processor processes the second user client data to display a view of the second user workspace on the first client device, and the server accepting first user inputs to copy one or more of the second user graphical elements to the first user workspace.

In an aspect, the invention relates to a computer implemented method of social networking. The method includes providing system graphical user interface data from a server to a plurality of client devices, wherein the system graphical user interface data is configured to provide a system graphical user interface on a respective client device when a respective client processor processes the system graphical user interface data. The method also includes the server receiving respective client data via the system graphical user interface through a respective client device to establish respective user workspaces and populate the user workspaces with one or more respective user graphical elements, and associating additional data with at least one of the respective user graphical elements. The method also includes the server providing a second user client data to a first client device, wherein the second user client data provided by the server is configured to allow the first client device processor to process the second user client data to display a view of the second user workspace on the first client device; and the server accepting first user inputs to copy one or more second user graphical elements to a first user workspace.

In an aspect, a computer-readable medium storing a set of instructions for execution by a general purpose computer to perform a method of social networking. The set if instructions include a first providing code segment for providing system graphical user interface data from a server to a plurality of client devices, wherein the system graphical user interface data is configured to provide a system graphical user interface on a respective client device when a respective client processor processes the system graphical user interface data. The set of instructions also include a receiving code segment for the server receiving respective client data inputted through the system graphical user interface through a respective client device to establish respective user workspaces and populate the user workspaces with one or more respective user graphical elements, and associating additional data with at least one of the respective user graphical elements. The set of instructions also include a second providing segment for the server providing a second user client data to a first client device, wherein the second user client data provided by the server is configured to allow the first client device processor to process the second user client data to display a view of the second user workspace on the first client device; and an accepting code segment for the server accepting first user inputs to copy one or more second user graphical elements to a first user workspace.

### BRIEF DESCRIPTION OF THE DRAWINGS

The following detailed description of the preferred embodiments of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1A illustrates a graphical user interface in the form of a first virtual room and graphical elements representing objects within the graphical user interface.

FIG. 1B illustrates the graphical user interface of FIG. 1A where a first one of the graphical elements, representing a Blog Board, is opened.

FIG. 1C illustrates the graphical user interface of FIG. 1A where a second one of the graphical elements, representing a Journal, is opened.

FIG. 2A illustrates a graphical user interface in the form of a second virtual room and a graphical element within the graphical user interface representing an object.

FIG. 2B shows a flow chart listing steps to copy a graphical element from one virtual room to another.

FIG. 2C illustrates the graphical user interface of FIG. 2A after a graphical element from a different virtual room is copied into the second virtual room.

FIG. 3A illustrates a graphical user interface in the form of a third virtual room with a graphical element representing an object.

FIG. 3B illustrates a graphical user interface provided by the social network system that includes a system provided set of graphical elements representing objects, controls to search, sort or filter system provided graphical elements, and a control to initiate creating a graphical element.

FIG. 3C shows a flow chart listing steps to copy a graphical elements from the set of system provide objects to the third virtual room.

FIG. 3D illustrates the graphical user interface of FIG. 3A after a graphical element from the set of system provide graphical elements is copied into the third virtual room.

FIG. 4 shows a flow chart listing steps to move a graphical element within a virtual room.

FIG. 5A illustrates a graphical user interface in the form of a fourth virtual room with two graphical element representing objects.

FIG. 5B shows a flow chart listing steps of creating a new graphical element.

FIG. 5C illustrates the fourth virtual room with a new graphical element created by steps listed in FIG. 5B.

FIG. 5D illustrates the fourth virtual room with a new graphical element created by steps listed in FIG. 5B and control features that can be provided for manipulation of the graphical element.

FIG. 6A shows a flow chart listing steps of adding content to a graphical element.

FIG. 7A illustrates implementing the graphical user interface provided by the social network system of FIG. 3B to search for particular graphical elements.

FIG. 7B illustrates the graphical user interface provided by the social network system of FIG. 3B after the system returns the results of the search illustrated in FIG. 7A.

### DETAILED DESCRIPTION

Certain terminology is used in the following description for convenience only and is not limiting. The words “right,” “left,” “top,” and “bottom” designate directions in the drawings to which reference is made. The words “a,” and “one,” as used in the claims and in the corresponding portions of the specification, are defined as including one or more of the referenced item unless specifically stated otherwise.

Embodiments herein include a system for implementing a social network, a method of implementing a social network, and a computer-readable medium a computer-readable medium storing a set of instructions for execution by a general purpose computer to perform a method of social networking. The instructions may be processor-executable instructions which, when executed by at least one processor, will cause the at least one processor to perform the method of social networking.

In an embodiment, the system includes a network including a plurality of client devices including a first client device and a second client device. Client devices may include virtually any computing device capable of receiving and sending a message over a network, to and from another computing device, such as a server, or each other. Client devices may include devices that typically connect using a wired communications medium such as personal computers, multiprocessor systems, microprocessor-based or programmable consumer electronics, or network personal computers. The set of such client devices may also include devices that typically connect using a wireless communications medium such as wirelessly connected computers, cell phones, smart phones, pagers, walkie talkies, radio frequency (RF) devices, infrared (IR) devices, CBs, integrated devices combining one or more of the preceding devices, or virtually any mobile device. Similarly, client devices may be devices capable of connecting using a wired or wireless communication medium such as a PDA, POCKET PC, wearable computer, and any other device that is equipped to communicate over a wired and/or wireless communication medium.

Each client device may include a browser application that is configured to receive and to send web pages. The browser application may be configured to receive and display graphics, text, multimedia, and the like, employing virtually any web based language including but not limited to Standard Generalized Markup Language (SMGL), such as HyperText Markup Language (HTML); a wireless application protocol (WAP); a Handheld Device Markup Language (HDML), such as Wireless Markup Language (WML); WMLScript; or JavaScript.

Client devices may be further configured to receive a message from another computing device employing another mechanism, including, but not limited to email, Short Message Service (SMS), Multimedia Message Service (MMS), instant messaging (IM), internet relay chat (IRC), mIRC, or Jabber.

Client devices may be further configured to enable a user to manage a user profile, category information, activity participation, and the like, which may in turn be saved at a remote location, such as the server. As such, client devices may further include a client application that is configured to manage various actions on behalf of the client device. For example, the client application may enable a user to interact with the browser application to customize how another social network user might view a persona, profile, or other features associated with the user.

The system may also include one or more servers and network connectivity channels operably connecting the plurality of client devices and the one or more servers. The one or more servers may include any computing device capable of connecting to the network to manage a customization of a view associated with a user, such as a user of at least one of the client devices. Devices that may operate as the server include but are not limited to personal computers, desktop computers, multiprocessor systems, microprocessor-based or programmable consumer electronics, network personal computers.

A server may be configured to receive information associated with a user and to enable the user to customize a view based in part, on the received information. The received information may include but is not limited to personal data, room configuration, graphical elements loaded, and additional data associated with the graphical elements.

As used herein, “operably” connected means that the plurality of client devices and the one or more servers are able to communicate through the network connectivity channels to perform the social networking method. Network connectivity channels include but are not limited to a wireless interface and/or a wired interface. Wired interfaces are known in the art and include but are not limited to analog telephone lines, full or fractional dedicated digital lines including T1, T2, T3, and T4, Integrated Services Digital Networks (ISDNs), and Digital Subscriber Lines (DSLs). A wireless interface may include but is not limited to radio or satellite connections. A wireless interface my operate through a wireless standard including but not limited to bluetooth, Global System for Mobile communications (GSM), Enhanced Data rates for GSM Evolution (EDGE), General Packet Radio Service (GPRS), cdma2000, wideband CDMA (W-CDMA), long term evolution (LTE), 802.11x, Wi-Max, or mobile Wi-MAX.

The system also includes a computer-readable medium. The term “computer-readable medium” includes but is not limited to a register, a cache memory, a read-only memory (ROM), a semiconductor memory device such as a Dynamic Random Access Memory (D-RAM), Static RAM (S-RAM), or other RAM, a magnetic medium such as a flash memory, a hard disk, a magneto-optical medium, an optical medium such as a CD-ROM, a digital versatile disk (DVDs), or Blu-Ray disc (BD), other volatile or non-volatile memory, or other type of device for electronic data storage. A “memory device” is a device configurable to read and/or write data to/from one or more computer-readable media.

The system also includes social network instructions encoded on a computer-readable medium. Each of the plurality of client devices includes respective client processors, and each of the one or more servers includes respective server processors configured to implement the social network instructions.

Implementation of the social network instructions includes providing system graphical user interface data from the server to two or more of the plurality of client devices. The respective client processors can process the system graphical user interface data to display a system graphical user interface on the respective client devices. The system graphical user interface may include one or more “page” with various features. The features may allow the users to implement the social network by inputting data or receiving information from the server. The system graphical user interface can be configured to allow a respective user to input respective client data to establish a respective user workspace. A user workspace can be displayed on the user client device and may be referred to a as a user room. The user room is a virtual space where the user establishes its presence in the social network. And the system graphical user interface can also be configured to allow a user to populate the user room with one or more user graphical elements. The graphical elements, also called “widgets” or “furnii,” are representations of objects. The objects may be but are not limited to physical entities (such as but not limited to mp3 players, furniture, movie screens, books, and maps), plants, animals, or even people. The user may interact with the system graphical user interface to create a new graphical element and copy the new graphical element to its room. The system may include one or more type of pre-made graphical element, which could be stored on computer-readable medium accessible to the server. A user may be able to copy a pre-made graphical element through the system graphical user interface. Also, a user may be able associate additional data with at least one of the one or more graphical elements. The additional data may be added through implementation of the system graphical user interface, or locally on the user client device. If added locally, the system may allow the user room to be updated with the locally added information through communication between the client device and the server.

Implementation of the social network instructions also includes allowing users to visit the rooms of other users. The graphical elements and additional data therein may be accessed by the visiting user, and the visiting user may copy graphical elements from the other user rooms to its own room. Copying a graphical element can be referred to as “raiding” the graphical element. To implement this function, the server may provide second user client data to a first client device, wherein the first client device processor processes the second user client data to display a view of the second user room on the first client device. Also, the server may accept first user inputs to copy one or more of the second user graphical elements to the first user room. In an alternative or additional embodiment, “raiding” may include deleting a graphical element form one room while adding it to another.

An embodiment includes a computer implemented method of social networking that includes providing system graphical user interface data from a server to a plurality of client devices. The system graphical user interface data can be configured to provide a system graphical user interface on a client device when a client processor processes the system graphical user interface data. The server may receive client data inputted through the system graphical user interface through a client device to establish user rooms and populate the user rooms with one or more respective user graphical elements. The user may load additional data into a graphical element. Additional data may be loaded through the system graphical user interface. The server may associate the additional data with at least one of the respective user graphical elements in order to display the transformed graphical element with the additional data to other users.

A user may visit other user sites through the method. To this end, the server may provide second user client data to a first client device, wherein the second user client data provided by the server is configured to allow the first client device processor to process the second user client data to display a view of the second user room on the first client device. The server may also accept first user inputs to copy one or more second user graphical elements to a first user room.

An embodiment includes a computer-readable medium storing a set of instruction for performing a method of social networking. The set of instructions include a first providing code segment for providing system graphical user interface data from a server to a plurality of client devices, wherein the system graphical user interface data is configured to provide a system graphical user interface on a respective client device when a respective client processor processes the system graphical user interface data. The set of instructions also include a receiving code segment for the server receiving respective client data via the system graphical user interface through a respective client device to establish respective user workspaces and populate the user workspaces with one or more respective user graphical elements, and associate additional data with at least one of the respective user graphical elements. The set of instructions also include a second providing segment for the server providing a second user client data to a first client device, wherein the second user client data provided by the server is configured to allow the first client device processor to process the second user client data to display a view of the second user workspace on the first client device. The set of instructions also include an accepting code segment for the server accepting first user inputs to copy one or more second user graphical elements to a first user workspace.

The system or method herein may be configured to allow a user to input personal data and for the server to receive said data. In addition, the personal data, or a portion thereof, may be associated with graphical elements within the user room at the direction of the system and/or the user. A user may be allowed to modify the appearance of its graphical elements, and the server may be configured to store the modified graphical elements on the computer-readable medium.

In an embodiment, advertising content or tags are included on a graphical element. By including advertising content on the graphical elements, the advertising content can be distributed amongst the social network users. By including tags, user preferences and/or behavior can be tracked. The system may store the user preferences and/or behavior on the computer-readable medium. In addition the system may provide the user preferences and/or behavior to a third party. Non-limiting examples of preferences and/or behavior include what type of graphical elements, advertising, or additional data appeal to the user; which types of rooms are visited by a user; what kind of other user rooms are visited by a user; which graphical elements are copied from other user sites by a user; and the kind of additional data a user adds to its graphical elements.

In an embodiment, the system includes multimedia storage, file transfer and sharing; advertisement distribution; and consumer behavior tracking capabilities through a social network, which can be referred to as “RAID MY ROOM” or “RMR.” The system may include the social network in a multi-media interface, built around graphical elements that allow users to creatively display their social identities and connect with others via the structure and style of their own virtual rooms. Furnishings with a user's virtual room may include furniture and accessory inspired multi-media widgets, also called “furnii,” which can be at least a portion of the networking activity on RMR. The furnii can be used as a medium for displaying or distributing advertising. In addition, furnii can be tagged with key words and descriptors, which may be utilized to provide consumer behavior data. The consumer behavior data can be utilized in, for example, consumer marketing campaigns.

Furnii within RMR can be used by individual users to convey identity. In addition, furnii can be the basis for networking on the system via the use of tags. For example, an RMR user may decorate his room with a furnii that is personally customized to look like a journal, which contains a blog about his passion, French bulldogs. This furnii may be tagged with terms such as “French bulldog,” “bulldog,” “dogs,” or “breed.” Other system users who also love the breed can search all furnii related to French bulldogs, raid the blogger's room and take a copy of this furnii for their own rooms. Raiding a furnii could be copying a furnii from one user room to another, or removing a furnii from one user room and placing it in another. Users can be networked together based on their common interest, and could communicate and continue to update the content of a shared furnii together in the hopes of attracting more users to raid the mutable furnii, and create a large network of French bulldog lovers. In an embodiment, a user can use any image or media file to modify furnii, rather than being limited to a pre-set menu of options. A pre-set menu of options for modification of a furnii may be available to a user.

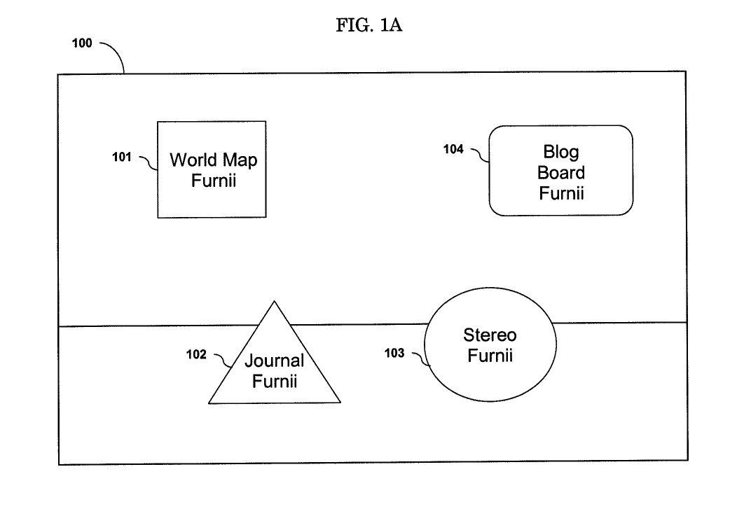

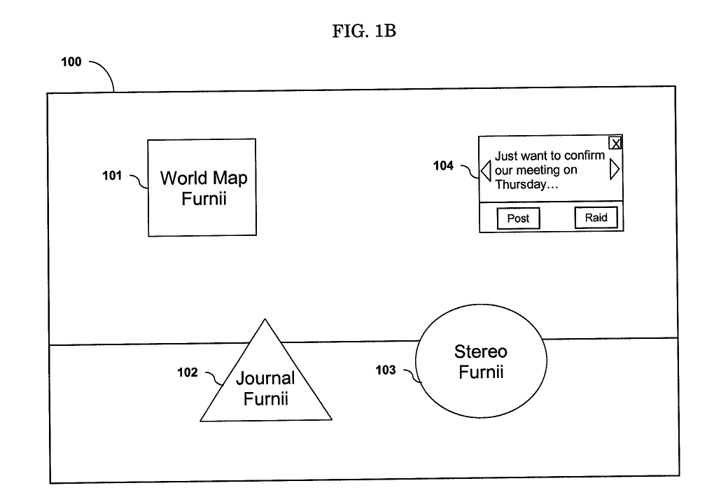

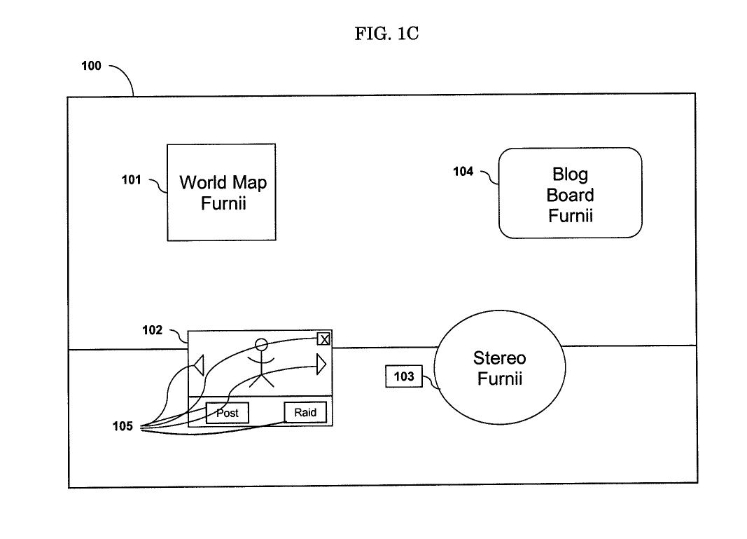

Referring to FIGS. 1A to 1D, elements of the social networking system and method are illustrated. A first user room 100 can be password protected and require a login in order to operate the room. The first user room 100 can also include a provision to optionally lock the room to all but other users that are granted a key by the first user. The key may be in the form of a password, digital certificate, or other means known in the art for allowing selective access to a web site. In FIG. 1A, different furnii are illustrated in a first user room 100, including a world map 101, journal 102, stereo 103, and blog board 104 furnii. These representations of real world objects decorate the user's room. As illustrated in FIG. 1A, a furnii could be located anywhere within the first user's room.

The first user can activate a furnii and view additional data therein. In the embodiment illustrated in FIG. 1B, the first user clicks on a blog board furnii 104 to reveal messages within the blog board. Additionally, the additional data can be modified by the first user or, as illustrated (“Just want to confirm our meeting on Thursday . . . ”), the additional data could be left by a second user that had previously visited the room and used the blog board to leave a message.

As illustrated in FIG. 1C, a furnii can represent a journal 102. Within the journal 102, the first user can deposit files. The files could be photographic files but could be of any type, including, but not limited to photographic, audio, text, RSS feeds or video files. A furnii can include controls to manipulate the furnii or the content of the furnii. In FIG. 1D, the journal furnii 102 includes previous, next, post, raid, and close controls 105. In the embodiment illustrated, a user could position the cursor over the control and click a mouse key to activate the control 105.

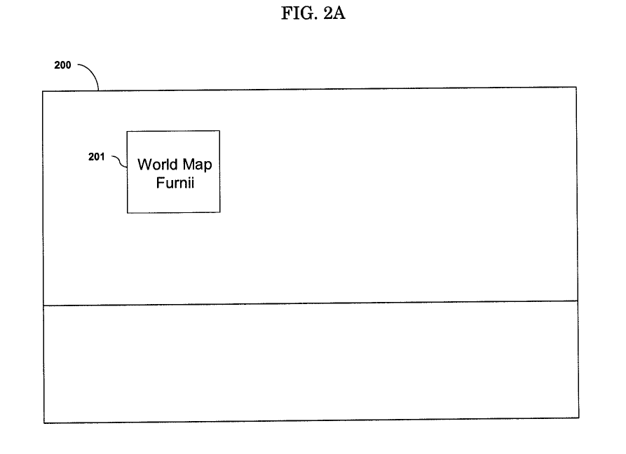

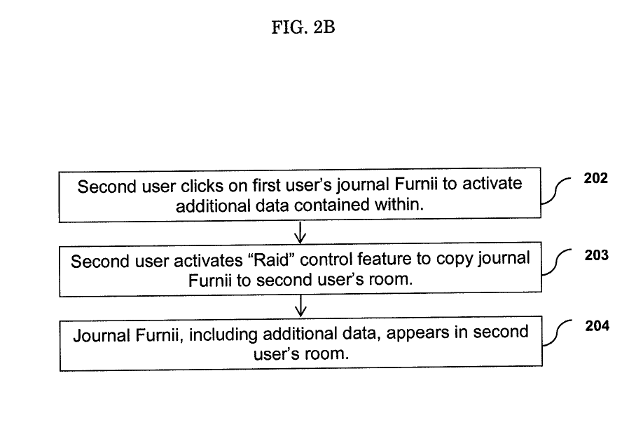

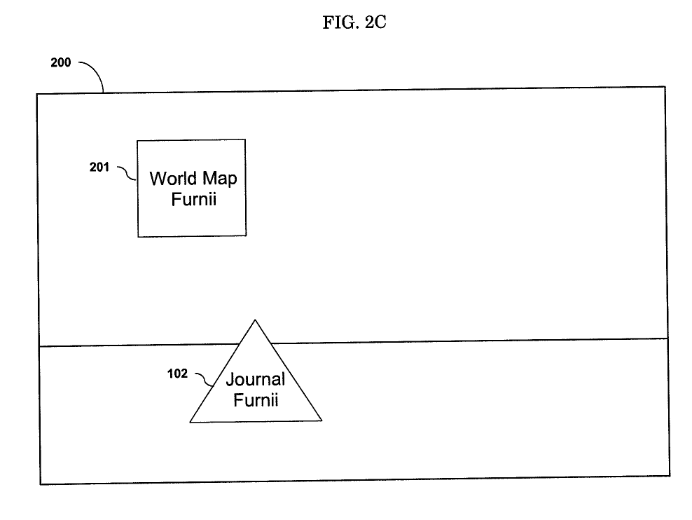

FIGS. 2A to 2D illustrate an embodiment of “raiding” a furnii. A second user room 200 is illustrated with a world map furnii 201. The second user can visit other user rooms and may visit the first user room 100, which includes the journal furnii 102, which may contain additional data. FIG. 2B illustrates steps of inspecting and raiding the journal furnii 102. Within or on a furnii, control features can be provided to manipulate the furnii. At step 202, the second user examines additional data by clicking on the journal furnii 102. Then, the second user activates a “Raid” control feature at step 203 by clicking on a “Raid” button. See, for example, the Blog furnii 104 in FIG. 1B, which shows a “Raid” button. By clicking the “Raid” button, the journal furnii 102 is copied to the second user site at step 204. In this context, a user copying a furnii can be referred to as a “raider.” As shown in FIG. 2C, the raided journal furnii 102 appears within the second user room 200. The system may be implemented such that the additional data within a furnii is left behind in the raided user room, or copied along with a copy of the furnii to raider's site. For example, the journal furnii 102 copied into the second user site 200 may include the additional data associated with the journal furnii 102 originally within the first user site 100.

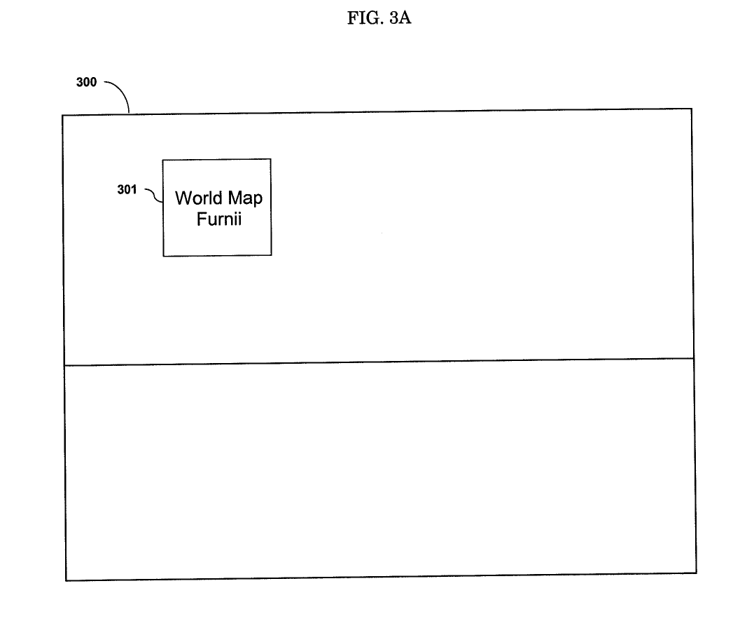

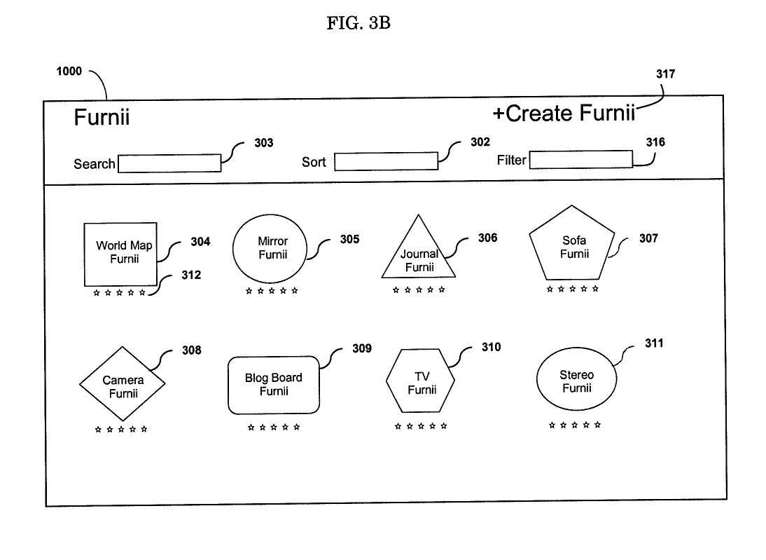

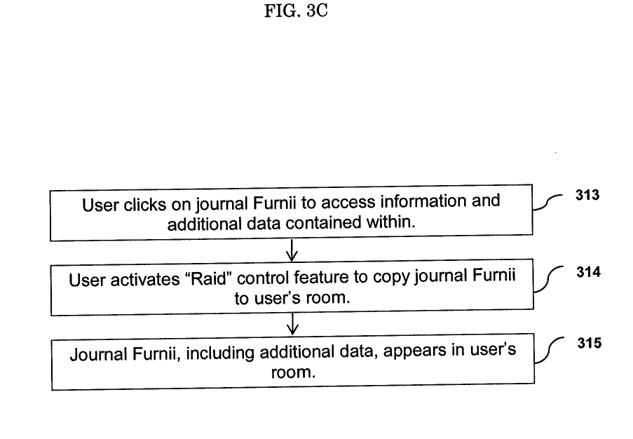

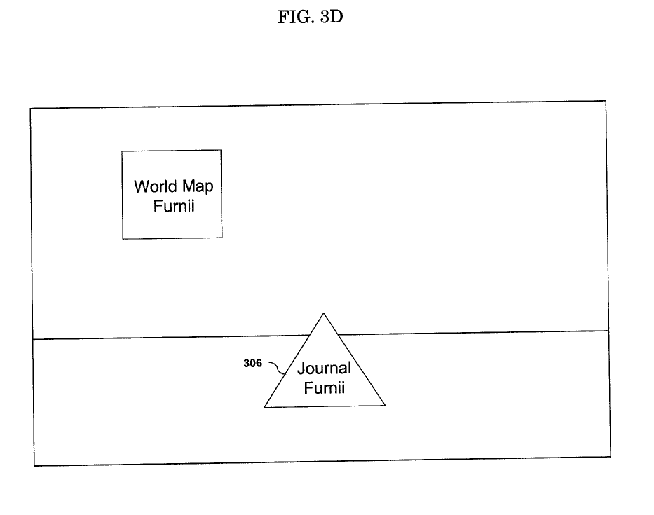

Referring to FIGS. 3A to 3D, an embodiment is illustrated where furnii are copied from the system graphical user interface, which may be referred to in this embodiment as the main furnii page. The process of copying a furnii from the main furnii page can be referred to as “raiding” the furnii from the main furnii page. The main furnii page may include furnii that are not yet associated with a user site. In addition, the main furnii page may be configured to catalog or show furnii already associated with a user room. In FIG. 3A, the user room 300 is illustrated with a world map furnii 301. FIG. 3B illustrates a main furnii page 1000, which may be visited by a user. In the embodiment illustrated, furnii can be searched by keyword through search window 303, sorted by category through the sort window 302, or filtered through filter window 316. As stated, the furnii can be searched by keyword, but the furnii could be searched, sorted, or filtered on any basis. The furnii choices can be presented as symbols, alphanumeric menus, as a series of graphical representations, or any combination thereof. As illustrated in FIG. 3B, the furnii choices are presented in a series of graphical representations 304, 305, 306, 307, 308, 309, 310, and 311. Ratings 312 from users could be associated with the furnii. FIG. 3C lists steps of raiding furnii from the main furnii page 1000. The user may be able to inspect or open furnii at step 313. Once the user identifies a furnii it would like to copy, for example the journal furnii 306, the furnii can be activated. In an embodiment, the user clicks the furnii graphic to activate it. By activating the furnii, the control features are accessed and the user can activate the “Raid” control feature at step 314. As indicated in step 315 and in FIG. 3D, activating the raid control causes the journal furnii 306 to be copied to the third user room 300. Additional data within journal furnii 306 may also be copied into this new graphical element in the third user room 300.

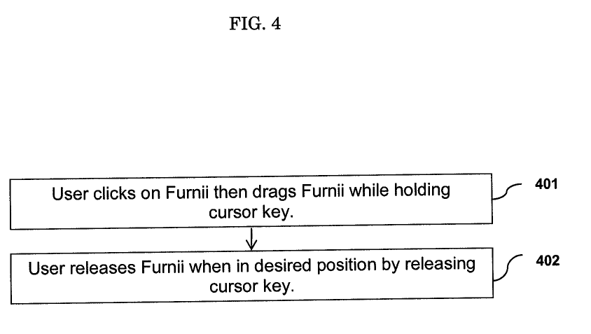

Referring to FIG. 4, a method of moving a furnii within a room is illustrated. In the embodiment depicted, a user clicks on a furnii and then drags the furnii while holding the cursor key in step 401. Once the furnii is in a desired position, the user releases the cursor key at step 402. Other methods of moving graphical elements are known in the art and could be implemented in any of the embodiments herein.

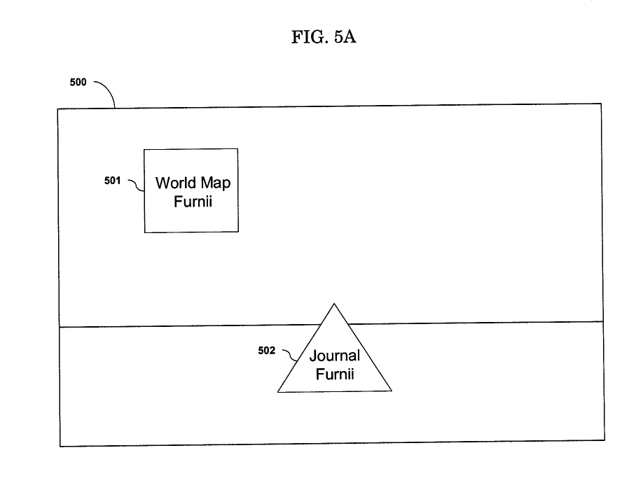

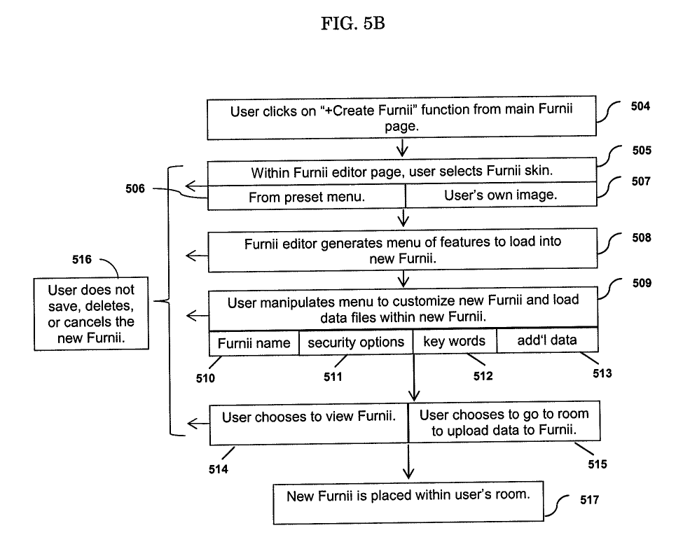

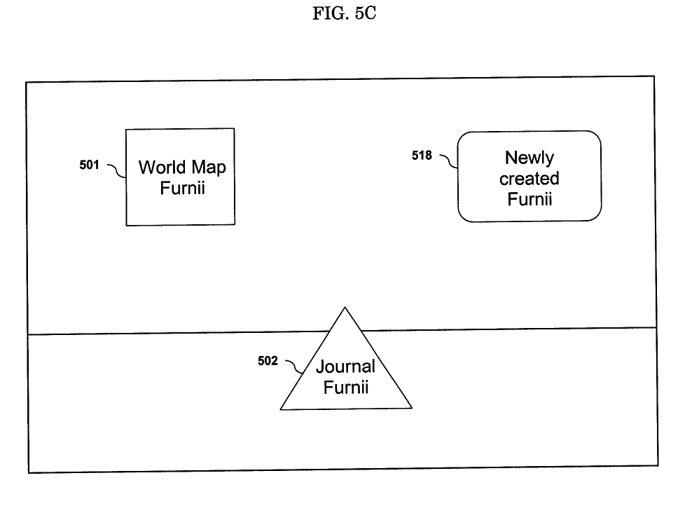

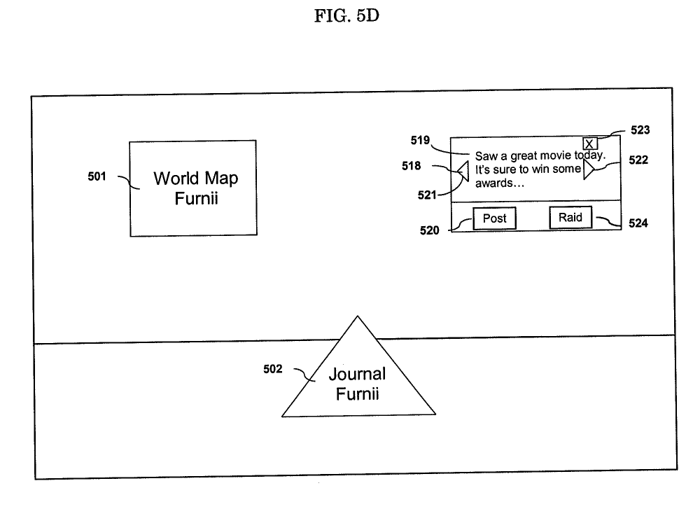

In an embodiment, new furnii may be created and FIGS. 3B and 5A to 5E illustrate one method of creating new furnii. A user room 500 is depicted in FIG. 5A with only two furnii 501 and 502. As shown in FIG. 3B, however, a main furnii page 1000 can also include a create furnii 317 function. At step 504 of FIG. 5B, the user clicks on the create furnii 317 function, and a furnii editor page is presented. In the furnii editor page, the user can select the “skin” or outward appearance of the furnii. This can be accomplished from a menu of options, as indicated at step 506, or by uploading a user's own image, as indicated at step 507. Upon indication of what appearance the furnii will have, the furnii editor may generate a menu of features to load into the new furnii, as indicated at step 508. The user may manipulate the menu to customize the new furnii and load data or files within it, as indicated at step 509. The menu of features to load may include but is not limited to the furnii name, security options, key words, and content or data, as indicated at steps 510, 511, 512, and 513, respectively. The user could be provided the option of viewing the new, customized furnii, as indicated at step 514, or going to the user room where the new furnii resides, to upload additional data, as indicated at step 515. See FIG. 5C. In an embodiment, at any point in the process of creating a new furnii, the user could also end the process without saving or by deleting or canceling the modified furnii, as indicated at step 516. FIG. 5C illustrates the new saved furnii 518 placed within the user room, as indicated at step 517 of FIG. 5C. The control features within the furnii allow a user to modify the furnii. As FIG. 5D illustrates, the new furnii 518 with a window 519 where control features allow the user to post/create or edit a message or other data entry within the furnii by operation of control feature 520. A user could also be provided with a view previous data entry control 521, a view next data entry control 522, a close furnii control 523, or a raid furnii control 524.

Other control features can also be included or added to furnii. The specific control features can be adapted for the type of furnii or the type of additional content intended for or actually associated with the furnii. For example, a diary furnii can include control features that facilitate creating, editing, and removing diary entries. If a user adds photographic files to the diary, however, the system could be configured to detect the addition and add control features to the furnii that are appropriate for the maintenance or editing of photographic files. In addition, the user could add or delete control features. Other control features could be listed, for example, on a menu within a furnii or on a menu on the furnii main page 1000.

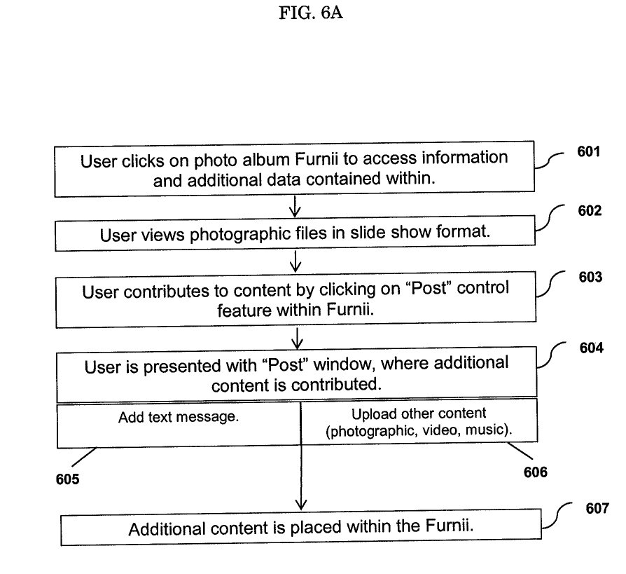

FIG. 6A illustrates a method to add content to an existing furnii. As a non-limiting example, a user clicks on a photo album furnii to access information and additional data contained within, as indicated at step 601. Within the photoalbum furnii, photographic files are loaded and the user may view in the files, as indicated at step 602. While viewing the contents within the furnii, the control features, including the “Post” control feature, could be activated. The user may contribute to the furnii by clicking on the “Post” control feature, as indicated at step 603. The user contributions are not limited, but by way of example the contribution could include comments or the addition of further photographic files. After clicking on the “Post” control, the user is presented with a “Post” window, as indicated at step 604. The user may post a text message, as indicated at step 605, or may select other content (for example, photographic, video, or music files) and upload the selected content into the furnii (“Submit”), as indicated at step 606. Devices and methods to select or submit content may include any known device or method to access storage media of a user computer to retrieve a file stored therein. Alternatively, the devices or methods may allow access to content stored on other devices or third party databases. Once the user clicks on the “Submit” control feature, the additional content is placed within the furnii, as indicated at step 607. The foregoing represents non-limiting ways to add content to a furnii. Any method or device known in the art for associating data with a graphical element may be implemented to add content to a furnii.

In an embodiment, available content may be restricted by the administrator of the system. In another embodiment, a first user that controls a particular room may be allowed to restrict the content that other users could add to the room or furnii within the room. In such an embodiment, a restricted furnii that is copied to another user's room could retain the restriction. Alternatively, the other user could remove or alter the restrictions on the copy of the restricted furnii upon or after copying the restricted furnii. In a still further alternative, the copy of the restricted furnii that appears in the other user's room could be free of the restrictions.

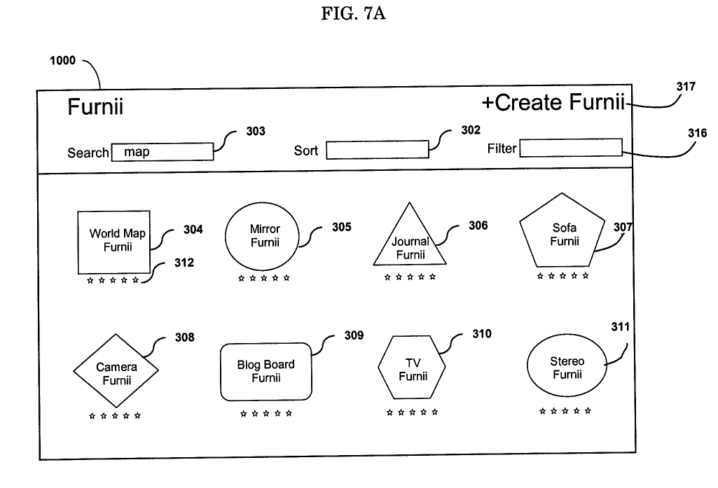

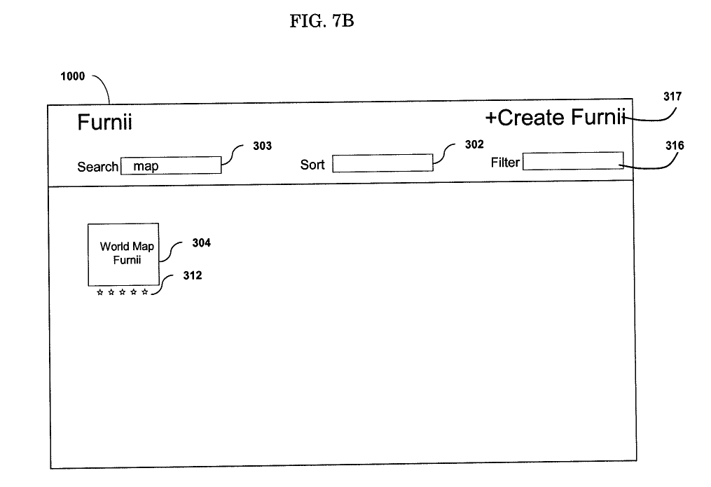

FIGS. 7A to 7B illustrate searching for furnii. FIG. 7A illustrates the main furnii page 1000 where the search field 303 is filled in with the search term “map.” By activating the search, furnii tagged with the keyword “Map” are returned as a search result on the furnii main page 1000. See FIG. 7B. A user could also sort furnii using the sort field 302 or filter furnii or search results with the filter field 316. For example, the type or style of furnii can be sorted, or unwanted furnii could be removed from the listing. The sort or filter could be based on features such as but not limited to colors, latest entry, oldest entry, name, or rating.

Other methods or systems to manipulate or view furnii could be implemented. For example, the content of a furnii could be revealed when a user scrolls over a furnii, rather than by clicking on it.

Implementation of embodiments of the invention described herein may be accomplished by methods known in the art for distributing information by the internet and in particular for design and administration of a web site on the world wide web. The World Wide Web is a system of interlinked hypertext documents accessed via the Internet. With a web browser, one can view web pages that may contain text, images, videos, and other multimedia and navigate between them using hyperlinks. The web site (a collection of electronic files residing on one or more web servers) presents content (possibly including interactive features or interfaces) to the end user in the form of web pages. A user workspace, the system graphical user interface and other features of the social network may be presented on or as part of a web page. Elements such as text, forms, and bit-mapped images (GIFs, JPEGs, PNGs) can be placed on the page using languages including but not limited to HTML, XHTML, or XML tags. Displaying more complex media (vector graphics, animations, videos, sounds) can be accomplished utilizing plug-ins such as Flash, QuickTime, Java run-time environment, etc. Plug-ins are also embedded into web pages by using HTML or XHTML tags.

Improvements in the various browsers' compliance with W3C standards could allow implementation of the embodiments with XHTML and XML in conjunction with Cascading Style Sheets (CSS) to position and manipulate web page elements. The latest standards could allow delivery of a wide variety of media and accessibility options to the user, possibly without employing plug-ins.

Typically web pages are classified as static or dynamic. Static pages do not change content and layout with every request unless a human (web master or programmer) manually updates the page. Dynamic pages adapt their content and/or appearance depending on the end-user's input or interaction or changes in the computing environment (for example, user, time, and database modifications) Content can be changed on the client side (end-user's computer) by using client-side scripting languages (for example, JavaScript, JScript, Actionscript, media players and PDF reader plug-ins) to alter DOM elements (DHTML). Dynamic content is often compiled on the server utilizing server-side scripting languages (including but not limited to PHP, ASP, Perl, Coldfusion, JSP, and Python). Implementation of embodiments of the invention described herein can be accomplished with dynamic pages. Static pages may also be utilized.

A description of web site design can be found in MacDonald, M. Creating Web Sites: The Missing Manual (October 2005); The Missing Manuals Series, ISBN 10: 0-596-00842-2, O'Reilly Media, Inc., which is incorporated by reference herein as if fully set forth. Additional web site design guidance can be found in Lynch, P. and Horton S. Web Style Guide 2^{nd} Edition (2002), ISBN 0-300-09682-8, Yale University Press, New Haven, which is incorporated by reference as if fully set forth.

A system for implementing the embodiments of the invention described herein may include client devices, a network, and one or more servers. The network is in communication with and enables communication between the client devices and one or more servers. The network can be enabled to employ any form of computer readable media for communicating information from one electronic device to another.

The system may be implemented through the Internet and/or across local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. The network may include any network connectivity channel or communication method by which information may travel between client devices and one or more servers.

Instructions to implement the social network described herein may be embodied as computer-readable instructions, data structures, program modules, or other data in a modulated data signal such as a carrier wave, data signal, or other transport mechanism and includes any information delivery media. The terms “modulated data signal,” and “carrier-wave signal” include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

A furnii can be configured to present a trademark, logo, or the appearance of a product. For example, furnii may be configured to appear as a COCA-COLA® can. The appearance of the furnii itself can serve as an advertisement. In addition, the additional data within a furnii can serve as an advertisement. An additional data advertisement could reside within the a furnii lacking any outward advertising appearance or on a furnii that outwardly appears like an advertisement. For example, additional data advertising a product could be loaded within a COCA-COLA® can furnii. When advertisements are part of furnii, the system can be utilized to distribute the advertisement through the social network implementation. As rooms are raided, the spoils of the raid may include the advertisement loaded furnii, and the advertiser's message is passed by “virtual word-of mouth.”

Advertisements can be part of furnii or room elements other than furnii. In an embodiment, a user can decorate its room with features other than furnii. For example, a user could be allowed to choose wall colors or designs. As a further example, a user room could be implemented to resemble of film-still. If a user room resembles a film-still, advertisers could use product placement as they would in the movies (rather than, for instance, banner advertisements). Product placement can include but is not limited to representations of the real products, posting symbols or trademarks. A movie studio could show a trailer from its latest movie, a soft drink company could advertise its beverage using a fizzing, exploding soft drink container. Advertiser furnii could be customizable and mutable. In an embodiment, an advertiser furnii may include aspects, such as advertising messages or images, that are not customizable or mutable. In another embodiment, an advertiser furnii is not customizable or mutable by a user but could be customizable or mutable to the administrator or advertiser. Advertiser furnii could be tagged with appropriate content or advertising terms that can be searched.

When a user selects and raids an advertiser furnii, the user will choose advertisements that will appear in their room. Advertisers could be provided access to advertiser furnii in a user room and could be allowed to continue to upload, modify, or delete furnii content within a user's room. Alternatively, advertisers access to furnii could be restricted in any of these aspects once the furnii is in a user room.

In an embodiment, furnii can be provided with a three-dimensional appearance. When moved around a page, a furnii could become proportionately larger or smaller. A corresponding shadow could be associated with furnii. By these features, the furnii can present a more realistic appearance, and particular furnii may have a more anthropomorphic quality.

Furnii could be infinitely customizable within size and file-type parameters by a user or advertiser in terms of content, “skins,” and other outward appearances. As described above, furnii can be utilized by the system's users as portals to their own and each other's stored media. In addition, the furnii can be utilized by advertisers to give users a portal to products underlying the advertisements. For example, a furnii including an advertisement for a particular brand of clothing could include a means for the user to link to a merchant or catalog of the merchandise for the brand. The means for the user to link may be as simple as listing of the merchant's physical address, phone number, or name. Alternatively, or in addition, the means for the user to link may include electronic means such as a hyperlink or voice over internet protocol connection.

In an embodiment, the system is configured to collect consumer behavior data. The consumer data includes the gathering of demographic and usage data of visitors to a website. RMR can be configured to harvest specific demographic information from its users. The specific demographic information can be helpful to advertisers. For instance, the system could be configured to allow users to search for and then select furnii created by advertisers (for example, a television furnii that encapsulates a movie studio's latest movie trailer) on the main furnii page. Further, the system could be configured to track what search terms were used to find a furnii, how long visitors browse a specific advertiser's products or content, which furnii are actually chosen to decorate a user's room based on aesthetics or other factors, or what kind of user searches for and selects a particular furnii for their rooms. The kind of user can be sorted by any personal criteria including, but not limited to age, sex, hair color, height, group membership information, social identity, geographic region of residence, political affiliation, music interests, art interests, state of residence, and country of residence.

Consumer data collected through the system could make virtual product, concept, or content testing a reality for advertisers, at a fraction of the cost associated with traditional “real world” methods. For example, a soda pop advertiser might use the system to test two new beverage bottle designs to see which is chosen more often and by whom. The system's consumer behavior data would therefore be a powerful yet economical research tool for companies who advertise on the site via furnii. Finally, because the advertisements encapsulated within furnii could be as dynamic as an advertiser and/or system makes them, they could surpass traditional banner ads in terms of depth of information and richness of user experience.

In various embodiments described above, the operations implemented in order to open or activate a feature of a web site included clicking on an image to reveal the contents of the feature. In addition, various specific steps were described to manipulate the feature or perform particular operations. The skilled artisan will recognize, however, that any device, program, or method of operating a computer through any input device is also contemplated. Preferably, the input device includes a graphical user interface.

All references, software, scripting languages, and standards cited herein are incorporated by reference as if fully set forth.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A system for implementing a social network comprising:
a network including a plurality of client devices including a first client device and a second client device; one or more servers, and network connectivity channels operably connecting the plurality of client devices and the one or more servers;
a computer-readable medium; and
social network instructions encoded on the computer-readable medium;
each of the plurality of client devices including respective client processors; and
each of the one or more servers including respective server processors configured to implement the social network instructions;
wherein implementation of the social network instructions includes:
providing system graphical user interface data from the server to two or more of the plurality of client devices, wherein the respective client processors process the system graphical user interface data to display a system graphical user interface on the respective client devices, the system graphical user interface configured to i) receive respective client data inputted by a respective user to establish a respective user workspace and populate the respective user workspace with one or more respective user graphical elements by performing at least one of creating a new graphical element or copying at least one pre-made graphical element and ii) associate additional data with at least one of the one or more graphical elements;
the server providing second user client data to the first client device, wherein the first client device processor processes the second user client data to display a view of the second user workspace on the first client device; and
the server accepting first user inputs to copy one or more of the second user graphical elements to the first user workspace.

2. The system of claim 1, wherein the system graphical user interface is further configured to allow a respective user to input respective user personal data.

3. The system of claim 1, wherein the server processors are further configured to associate at least a portion of the respective user personal data with one or more of the respective user graphical elements.

4. The system of claim 1, wherein the system graphical user interface is further configured to allow a respective user to modify the appearance of one or more of the respective user graphical elements.

5. The system of claim 1, wherein advertising content is included with one or more of the graphical elements.

6. The system of claim 1, wherein tags are included with one or more of the user graphical elements.

7. The system of claim 1, wherein the implementation of the social network instructions further includes the server processor tracking respective behavior and respective preferences of respective users and recording the respective behavior and respective preferences on the computer-readable medium.

8. A computer implemented method of social networking comprising:
providing system graphical user interface data from a server to a plurality of client devices, wherein the system graphical user interface data is configured to provide a system graphical user interface on a respective client device when a respective client processor processes the system graphical user interface data;
the server receiving respective client data via the system graphical user interface through a respective client device to establish respective user workspaces and populate the user workspaces with one or more respective user graphical elements, and associating additional data with at least one of the respective user graphical elements;
the server providing a second user client data to a first client device, wherein the second user client data provided by the server is configured to allow the first client device processor to process the second user client data to display a view of the second user workspace on the first client device; and
the server accepting first user inputs to copy one or more second user graphical elements to a first user workspace.

9. The method of claim 8, wherein the system graphical user interface is further configured to allow a respective user to input respective user personal data, the method further comprising the server receiving respective user personal data.

10. The method of claim 9 further comprising the server associating at least a portion of the respective user personal data with one or more of the respective user graphical elements.

11. The method of claim 8 further comprising the server receiving respective user inputs to modify the appearance of one or more of the respective user graphical elements.

12. The method of claim 8 further comprising the server associating advertising content with one or more of the graphical elements.

13. The method of claim 8 further comprising the server associating tags with one or more of the graphical elements.

14. The method of claim 8 further comprising the server tracking respective behavior and respective preferences of respective users and recording the respective behavior and the respective preferences on the computer-readable medium.

15. The method of claim 14 further comprising the server providing one or more of the respective behavior and the respective preferences to a third party.

16. A computer-readable medium storing a set of instructions for execution by a general purpose computer to perform a method of social networking comprising:
a first providing code segment for providing system graphical user interface data from a server to a plurality of client devices, wherein the system graphical user interface data is configured to provide a system graphical user interface on a respective client device when a respective client processor processes the system graphical user interface data;
a receiving code segment for the server receiving respective client data inputted through the system graphical user interface through a respective client device to establish respective user workspaces and populate the user workspaces with one or more respective user graphical elements, and associating additional data with at least one of the respective user graphical elements;
a second providing segment for the server providing a second user client data to a first client device, wherein the second user client data provided by the server is configured to allow the first client device processor to process the second user client data to display a view of the second user workspace on the first client device; and
an accepting code segment for the server accepting first user inputs to copy one or more second user graphical elements to a first user workspace.

17. The computer-readable medium of claim 16, the method further comprising an advertising associating segment for the server associating advertising content on one or more of the group consisting of one or more of the new graphical elements created through the system graphical user interface or one or more of the pre-made graphical elements copied from the system graphical user interface.

18. The computer-readable medium of claim 16, the method further comprising a tag associating segment for the server associating tags on one or more of the group consisting of one or more of the new graphical elements created through the system graphical user interface or one or more of the pre-made graphical elements copied from the system graphical user interface.

19. The computer-readable medium of claim 16, the method further comprising a tracking segment for the server tracking respective behavior and respective preferences of respective users and recording the respective behavior and the respective preferences on the computer-readable medium.

20. The computer-readable medium of claim 16, the method further comprising a third providing segment for the server providing one or more of the respective behavior and the respective preferences to a third party.
